(19) United States
(12) Patent Application Publication
(10) Pub. No.: US 2013/0026270 A1
(43) Pub. Date: Jan. 31, 2013

(54) APPARATUS FOR FEEDING GRINDING BODIES TO A GRINDING MILL

(71) Applicants: Simo Fransas, Kotka (FI); Yongsun Bae, Helsinki (FI); Ilkka Rekolainen, Helsinki (FI); Johannes Pylvänen, Helsinki (FI); Kaur Jaakma, Espoo (FI); Markus Strandvall, Helsinki (FI); Pasi Pohjola, Tampere (FI); Ali Salomäki, Helsinki (FI); Jouni Hyttinen, Espoo (FI)

(72) Inventors: Simo Fransas, Kotka (FI); Yongsun Bae, Helsinki (FI); Ilkka Rekolainen, Helsinki (FI); Johannes Pylvänen, Helsinki (FI); Kaur Jaakma, Espoo (FI); Markus Strandvall, Helsinki (FI); Pasi Pohjola, Tampere (FI); Ali Salomäki, Helsinki (FI); Jouni Hyttinen, Espoo (FI)

(73) Assignee: OUTOTEC OYJ, Espoo (FI)

(21) Appl. No.: 13/639,076

(22) PCT Filed: Apr. 11, 2011
(86) PCT No.: PCT/FI2011/050310

§ 371 Date: Oct. 2, 2012

(30) Foreign Application Priority Data
Apr. 12, 2010 (FI) 20100146

(51) Int. Cl. B02C 17/18

(52) U.S. Cl. 241/171

(57) ABSTRACT

The employed feed element in a grinding body feed apparatus of a grinding mill is the grinding bodies supply tank proper, in which the grinding bodies are charged from a ball hopper or storage. In connection with the supply tank, there is provided a grinding bodies discharge element, by means of which the grinding bodies are conducted to a duct serving as a feed chute and leading to the grinding mill, and via said duct, to the grinding mill proper. The opening and closing of the supply tank is carried out by external, opposing control elements that encircle the drum element of the supply tank in relation to its frame. By means of the feed device, it is possible to feed one ball at a time to the mill, in which case a correct number of balls can be supplied.

The present invention relates to apparatus for automatically feeding grinding bodies, such as grinding balls, to a grinding mill so that the feeding of grinding bodies is carried out from the feed apparatus to the grinding mill without any particular intermediate storage.

Mining industry uses balls, usually steel balls, for crushing ore in concentrating mills. The balls are transported and fed to grinding mills. In order to carry out said transporting and feeding operations, belt conveyors, trucks or elevators have conventionally been used, or the balls have even been transported and fed manually. With these methods, the problems have been how to achieve sufficient safety and reliability, as well as how to feed the correct number of balls to the grinding mill with good timing. These problems result in unwanted variation in the concentration process, as well as safety hazards in the form of falling balls. In current systems, the required number of balls must be added separately to each mill, which also is often carried out manually.

Generally mills are run according to power measurements, and grinding bodies are fed in order to maintain the desired power settings. In addition to power measurements, in semi-autonomous grinding mills (SAG mills), there are fairly commonly applied other complementary measurements, such as measuring the degree of fullness of the mill (for example power sensor/strain gauge in a lifter bar), acoustic measurement, weighing and measurement of lubricating oil pressure (or pressure fluctuation) in the mill bearing. Said measurements can be utilized either directly or indirectly for estimating the state of a mill. On the basis of the obtained state information, the settings of the grinding process can be adjusted, either by adjusting the feed and/or by adjusting the power settings parameters. When calculating the power settings parameters, the employed variables are time and within certain limits the feed. Unfortunately grinding bodies cannot be removed from the mill, which means that generally a mill is operated well within safety margins, with settings that remain slightly under the power peak.

In order to achieve a favorable grinding result, semi-autonomous grinding mills, where grinding is partly carried out by means of self-ground bodies, as well as ball mills, need a large number of grinding bodies, such as grinding balls. Owing to the wearing of grinding bodies, more grinding bodies must be fed in the grinding mill in the course of the grinding process. The required quantity is hundreds of grams of grinding bodies per ton of material to be ground, when said material is for example a material containing valuable metals and classified as ore. Grinding bodies must be added continuously as the grinding process continues and the mill is in operation. Often the grinding bodies are fed along with the material to be ground, for example onto a belt conveyor or a material hoisting device, from which they are further conveyed into the grinding mill.

U.S. Pat. No. 4,056,230 discloses a method of crushing particles of material in a ball mill, in which method a mixture composed of balls, particles to be crushed, solvent and lubricant is fed to a ball mill that already contains balls. The balls used as grinding bodies are recycled in the grinding process by separating the balls from the material to be removed from the mill and by returning the balls back to the mill along with the feed mixture to be ground. According to said U.S. Pat. No. 4,056,230, an essentially continuous grinding is achieved by using solvent and lubricant along with the feed. However, said patent publication does not disclose adjusting the feed quantities of balls used in the grinding process with respect to the wearing of the balls.

The U.S. Pat. No. 4,062,497 describes a grinding mill system, where the quantity of the material to be ground is optimized by recycling part of the material back to the mill. Neither does the patent referred to herein disclose that the quantity of balls serving as grinding bodies should be adjusted, nor that replacements for worn-out balls should be added. Moreover, the U.S. Pat. No. 5,873,532 describes a ball mill where the feeding of the material to be ground into the mill is adjusted. Likewise, the text of this patent referred to does not include any disclosure of balls to be fed as replacements for worn-out balls.

The U.S. Pat. No. 5,224,659 describes an apparatus for feeding balls to a grinding mill. The apparatus includes a feed chute connected to a hopper or a discharge chute, and an arrangement for feeding grinding balls to a mill sequentially one at a time. The feed apparatus comprises a number of levers operated by hydraulic actuators. A problem with this type of apparatus is the reliability of the hydraulic actuators and particularly any kind of actuators based on an auxiliary medium or transmission in conditions where mills and grinding circuits operate.

The Chinese utility model CN 2801293 Y describes a ball feeding apparatus for feeding balls in a mill. A ball lift in an endless chain lifts balls from a feed chute one at a time to a track, where a supply device further transfers the ball to the conveyor serving as the feeder. The device can be used for feeding only one ball at a time, and in addition, the problem of a possible blocking of the feed chute is still not solved.

The Chinese patent application CN 101532670 A describes a conveyor where steel balls are fed from a discharging device one at a time to clean the walls of a boiler and to remove ash from the boiler walls. Only one ball at a time can be fed by said device.

The object of the present invention is to eliminate drawbacks of the prior art and to realize a new and safer automatic feed apparatus and feed system of grinding bodies to be used in a grinding mill, by which apparatus and system a desired quantity of grinding bodies can be fed to a grinding mill essentially automatically, without any separate intermediate transport. The essential characterizing features of the invention are defined in the appended claims.

In a feed apparatus of grinding bodies for a grinding mill according to the invention, the employed feed element is the grinding bodies supply tank, into which grinding bodies are charged in a way known as such, for instance from a ball hopper or a ball storage. Moreover, in connection with the supply tank, there is provided a grinding bodies discharge element, by means of which the grinding bodies are conducted first to a duct serving as a feed chute and leading to the grinding mill, and via said duct, to the grinding mill. According to the invention, the motion generated by the conveyor is used for opening and closing the supply tank. In between the loading and unloading points, the supply tank is kept closed by means of locking elements provided at the ends thereof. The opening and closing of the supply tank is carried out by external, opposing control elements that turn the drum element of the supply tank in relation to its frame. For opening, the supply tank is provided with necessary control elements. The feeding of balls to the supply device is advantageously carried out by means of a mechanical feed device, in which case it is possible to feed one ball at a time, so that a correct number of balls can be inserted.

The supply tank proceeds along a track serving as the conveyor, supported by an endless conveyor chain and by intermediation thereof. The conveyor chain is placed in connection with the conveyor beam, either inside or outside. The conveyor beam is bent and supported by a support frame to form a three-dimensional structure, which also supports the actuator unit. The actuator unit is formed of an actuator part and a transmission part, which are arranged, in a way known as such, to move the conveyor chain. Essentially for facilitating the automatic feeding of grinding bodies, the operation of the feed apparatus of grinding bodies is advantageously controlled for example by means of the control system of the grinding mill, or, as an alternative, by means of a separate control system, by utilizing the obtained values regarding the wearing of the grinding bodies with each material to be ground, with respect to power intake, for example. The feed apparatus can be automated by connecting it for instance to an ore grain size measuring system, in which case a required quantity of balls can be fed to a desired mill. By way of example, automation can be realized by motion-sensitive switches placed at the loading and unloading points for observing the location of the transport wagon.

The supply tank according to the invention, used in a grinding body feed apparatus for a grinding mill, is advantageously a cylindrical element that can be rotated around its longitudinal axis. The supply tank is provided with a rotary drum element that can be opened and closed and is advantageously rotary with respect to its longitudinal axis, and by means of said drum element, the supply tank is filled and emptied of grinding bodies, and with a lid element that is stationary with respect to the drum element. The drum element of the supply tank is provided with guides, and respectively the loading and unloading stations of the conveyor are provided with guide pairs corresponding to said guides for opening and closing the supply tank without other external help. In addition, the drum element is provided with a guide, advantageously a guide strip, for opening it at a desired, optional unloading point. Further, the supply tank is fastened or geared at the ends so that it can be rotated to loading and unloading positions around its longitudinal axis at the loading and unloading stations. The end parts of the supply tank are provided with actuator-aided locking members for preventing an unwanted rotation thereof.

For feeding grinding bodies essentially automatically, both the feed and discharge elements of the feed apparatus are electrically connected to the grinding mill, and on the basis of the values obtained from the grinding mill, the operation of the feed element and respectively the discharge element is adjusted so that the grinding mill is essentially continuously filled with a quantity of grinding bodies that is advantageous for the grinding result. The feeding of the grinding bodies is adjusted according to the power measured from the grinding mill, or according to the measured feed, in which case the input setting is a certain number of balls per ton of material to be ground, because the wearing of the grinding bodies affects the power consumption of the grinding mill. Thus the adjusting of the grinding mill, for example as regards power consumption, is made more accurate by means of the essentially automatic feeding of grinding bodies according to the invention. Consequently, the grinding mill can advantageously be run with desired power settings. The apparatus according to the invention can be used for feeding grinding bodies to a grinding mill either essentially continuously or sequentially continuously or even one at a time, to the extent required by the power consumption measurements of the grinding mill.

A grinding body feed apparatus according to the invention for a grinding mill is advantageously operated so that when grinding bodies should be fed to the grinding mill, the supply tank is placed at the location of the unloading duct of the ball hopper or storage of the loading station. The drum element provided in the supply tank rotates, with respect to the lid element, by means of the forward pushing motion of the chain and the guide, and renders the supply tank in the open position, in which the grinding bodies contained in the unloading duct and corresponding to a certain quantity can roll from the unloading duct further to the supply tank. When the unloading duct is empty and all grinding bodies have rolled into the feed device, the system detects that the feed device is filled and starts the feed device, and as a result, the drum element rotates, in a direction that is opposite to the opening direction, by an angle of rotation corresponding to the opening angle, and the supply tank is closed as the guide provided therein hits the corresponding guide that is arranged in connection with the loading station. The conveyor system transports the filled feed device along with the chain further to the unloading station serving as the mill feed station. At the unloading station, the unloading of the feed device takes place so that when the feed device arrives at the unloading station, the corresponding guide arranged in connection with the unloading station hits the guide provided in the drum element of the feed device, and the drum element rotates with respect to the lid element by means of the forward pushing motion of the chain and the guide, and renders the feed device in the open position as the conveyor chain transfers the feed device forward. When the drum element of the feed device is completely open, the grinding bodies contained therein drop, through a feed chute provided in connection with the mill, to the mill housing, into the grinding process.

When the feed device is emptied, the system detects that the feed device is empty and starts the feed device, and as a result, the drum element rotates, in a direction that is opposite to the opening direction, by an angle of rotation corresponding to the opening angle, and the supply tank is closed as the guide provided therein hits the corresponding guide that is arranged in connection with the unloading station. The conveyor system shifts the empty feed device along the chain further to the loading station serving as the filling station of the feed device.

The description hereinbefore describes how the feed device is filled and discharged into the mill, when there is one single mill in the grinding circuit. The situation is somewhat changed, when the grinding circuit includes several mills. In that case the control system of the grinding mill guides the feed device to the unloading station above the chute placed at the correct mill and turns the corresponding guide arranged in connection with the unloading station to unloading position, in which case the feed device collides with it and turns the drum element open, as the conveyor chain shifts the feed device forward. When the drum element of the feed device is completely open, the grinding bodies contained therein drop, through a feed chute provided in connection with the mill, to the mill housing, into the grinding process.

The invention is described in more detail below, with reference to the appended drawings, where

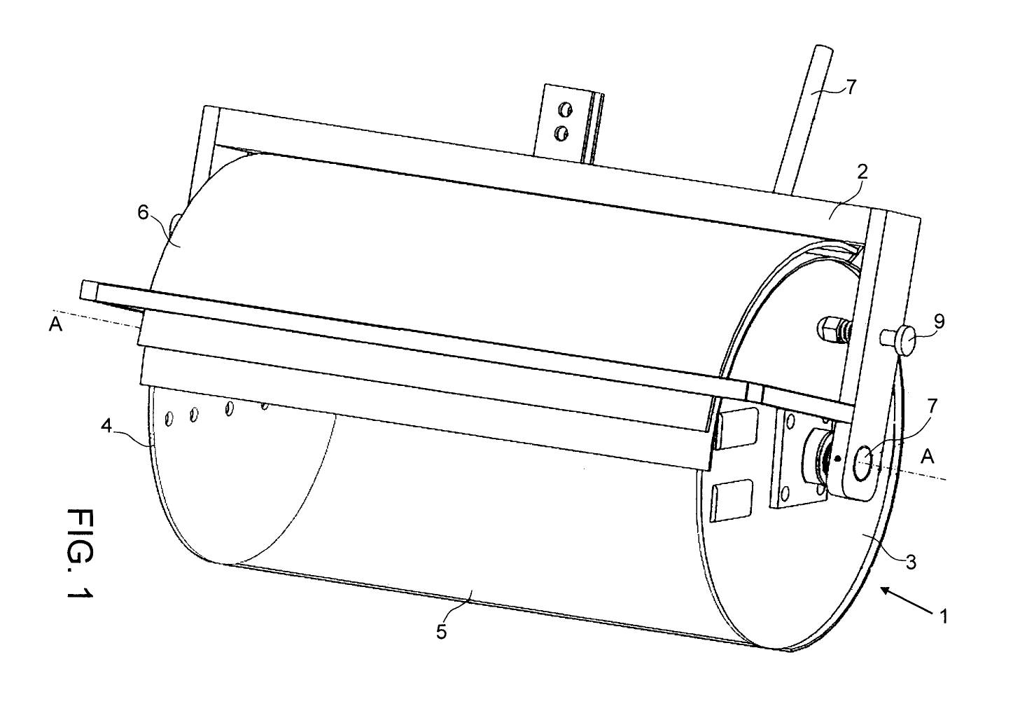

FIG. 1 illustrates a preferred embodiment of the invention, when the feed hatch is in the open position,

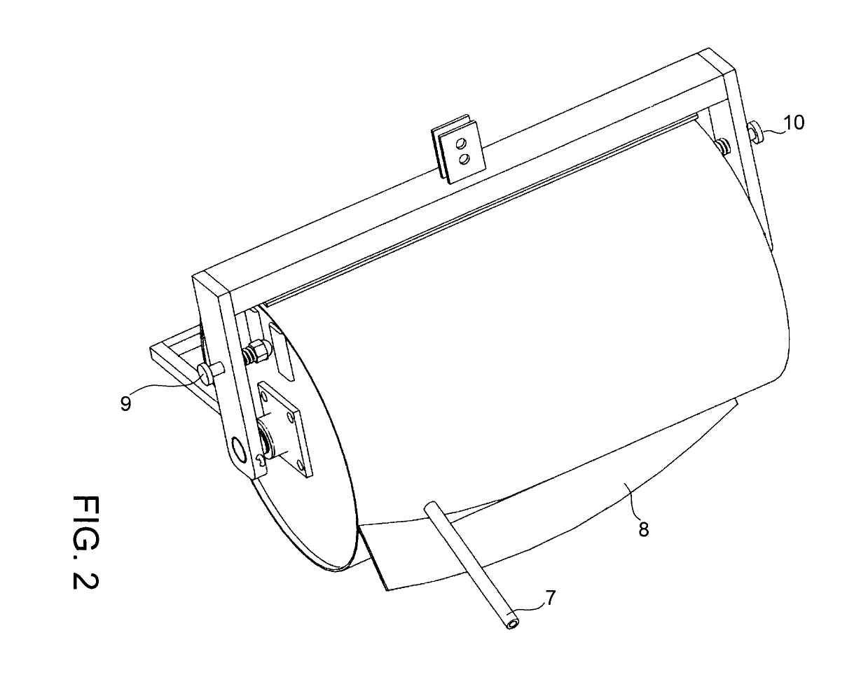

FIG. 2 illustrates an embodiment according to FIG. 1, when the feed hatch is closed,

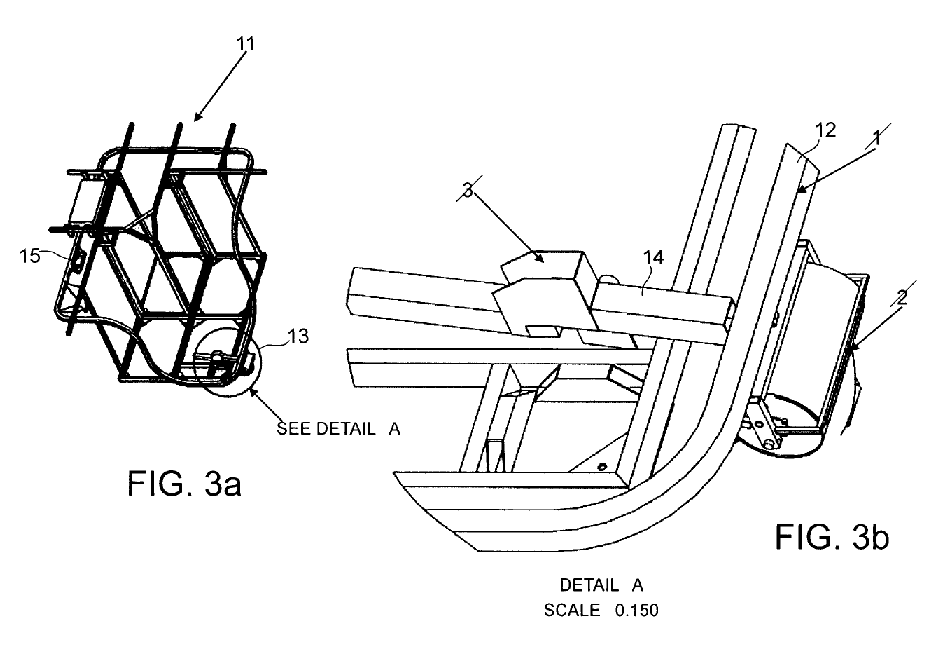

FIG. 3a illustrates another conveyor arrangement used when transporting a feed device according to the invention,

FIG. 3b illustrates a detail of the conveyor arrangement when the feed device is at the loading station,

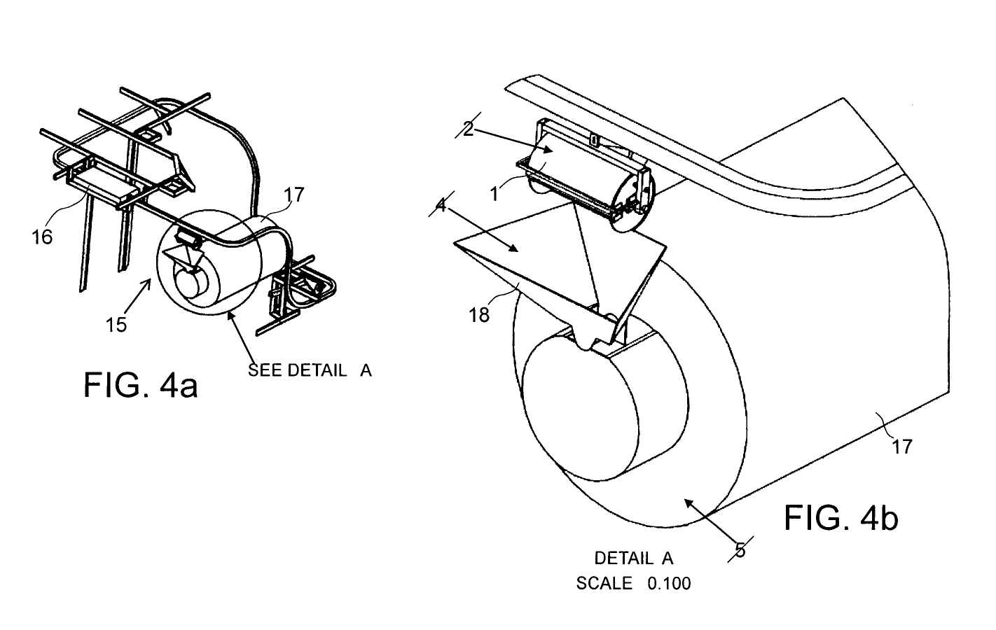

FIG. 4a illustrates a conveyor arrangement corresponding to the one illustrated in FIG. 3a, used for transporting a feed device according to the invention, also showing the grinding apparatus, and

FIG. 4b illustrates a detail of the conveyor arrangement, when the feed device is at the unloading station.

FIG. 1 illustrates a feed device 1 according to the invention for feeding grinding bodies to a grinding mill. The supply tank includes means 2 for suspending or fastening it at the ends from a conveyor chain (not illustrated). The supply tank 1 is formed of a cylindrical drum element 5 that is rotary around its central axis A-A, closed at the ends by a first end 3 and a second end 4 and partially open at the housing, as well as of a stationary lid element 6 that is attached to the means 2 and essentially corresponds to the open housing element. The drum element 5 is geared or supported by means of the means 2 and rotation elements 7 to be rotary around its longitudinal central axis A-A. The drum element 5 can be rotated with respect to the stationary lid element 6 for opening and closing the supply tank 1 in loading and unloading situations. To the lid element 6, there are fastened guide members that are outwardly protruding from its outer surface, i.e. a first guide member 7 and a second guide member 8 (illustrated in FIG. 2). Both ends of the supply tank 1 are provided with actuator-aided locking members 9 and 10, by means of which the drum element of the supply tank is locked, so that any rotation around the longitudinal central axis A-A does not take place. In FIG. 1, the supply tank is illustrated in the open position.

FIG. 2 illustrates a supply tank 1 according to the invention, corresponding to FIG. 1, for feeding grinding bodies to a grinding mill. Now the supply tank is illustrated from a view angle where the guide members 7 and 8 are better visible than in FIG. 1. In FIG. 2, the supply tank is illustrated in the closed position, so that the locking members 9 and 10 lock its drum element 5 in the closed position.

FIG. 3 shows, by way of example, a conveyor system 11 that is bent of hollow beam 12 (in FIG. 3b) to form an advantageously three-dimensional structure. The chain or other member conveying the supply tank 1 is not illustrated, but it is located, by way of example, inside the beam. In connection with the conveyor system 11, there is realized a loading station 13, and an exemplary arrangement thereof is illustrated in FIG. 3b. The loading station includes an unloading duct 14 of a ball hopper or storage (not illustrated). A grinding body feed apparatus according to the invention for a grinding mill is advantageously operated so that when grinding bodies should be fed to the grinding mill, the supply tank 1 is placed at the location of the unloading duct 14 of the ball hopper or storage of the loading station 13. The drum element 5 provided in the supply tank 1 rotates, by means of the forward pushing motion of the chain and the guide member 7, and the supply tank is opened in the open position, where the grinding bodies (not illustrated) contained in the unloading duct 14 and corresponding to a certain quantity can roll or be otherwise shifted from the unloading duct 14 further to the supply tank 1. When the unloading duct 14 is emptied and all grinding bodies have rolled into the supply tank 1, the system detects that the supply tank 1 is filled and starts the conveyor, and as a result, the drum element 5 rotates in a direction opposite to the opening situation by a corresponding angle of rotation, and the supply tank 1 is closed as the guide member 7 provided therein hits the corresponding guide arranged in connection with the loading station. The conveyor system 11 transports the filled feed device 1 further to the unloading station 15 serving as the mill feed station (illustrated in more detail in FIGS. 4a and 4b).

FIG. 4a is an exemplary illustration of the unloading station 15 and of an advantageous location of the drive equipment 16. At the unloading station 15, the unloading of the feed device 1 takes place so that as the feed device arrives at the unloading station, a corresponding guide (not illustrated) arranged in connection with the unloading station hits a second guide member 8 provided in the drum element 5 of the feed device, and the drum element 5 provided in the supply tank 1 rotates by means of the forward pushing motion of the chain and the guide member 8, and the supply tank is opened to the open position. When the drum element 5 of the feed device is completely open, the grinding bodies contained therein drop, through a feed chute 18 provided in connection with the mill 17, to the mill housing, into the grinding process.

The invention is by no means restricted to the preceding description only, but it may vary within the scope of the claims set forth below.

1. An apparatus for feeding grinding bodies to a grinding mill, so that the grinding bodies are transported from storage to the grinding mill, said apparatus including a grinding bodies supply tank and members for conveying grinding bodies from a reception tank to the grinding mill, wherein the supply tank (1) is provided with guide members (7, 8) for opening and closing the supply tank (4) at the loading and unloading stations (13, 15) of grinding bodies,
so that the supply tank is opened and closed as a result of the translatory motion of the supply tank (1) as well as corresponding guide members provided for the guide elements (7, 8) at the loading and unloading stations (13, 15).

2. An apparatus according to claim 1, wherein the supply tank (1) or part thereof is made rotary with respect to its longitudinal axis.

3. An apparatus according to claim 1, wherein the supply tank (1) is provided with locking members (9, 10) for locking it with respect to the rotation taking place around the longitudinal axis.

4. An apparatus according to claim 1, wherein it includes a plurality of feed apparatus (1) that are moved supported by a conveyor or transmission system (11).

5. An apparatus according to claim 1, wherein it includes a plurality of grinding apparatus (17), into which a number of feed apparatus (1) feeds grinding bodies according to given control commands.

6. An apparatus according to claim 1, wherein both the feed apparatus (1), the loading and unloading stations (13, 15) and the grinding apparatus (17) are electrically connected to a control unit for controlling the feeding of grinding bodies to the grinding apparatus (1).

7. An apparatus according to claim 1, wherein the operation of both the feed apparatus (1) and the loading and unloading stations (13, 15) can be controlled in order to adjust the grinding apparatus (17) on the basis of the power consumption of the grinding apparatus or the quantity of feed.

8. An apparatus according to claim 7, wherein both the loading station (13) and the unloading station (15) can be made to function essentially continuously.

9. An apparatus according to claim 7, wherein both the loading station (13) and the unloading station (15) can be made to function sequentially continuously.

10. An apparatus according to claim 7, wherein both the loading station (11) and the unloading station (13) can be made to function for feeding one single grinding body at a time.
